(19) United States
(12) Patent Application Publication
(10) Pub. No.: US 2018/0274787 A1
(43) Pub. Date: Sep. 27, 2018

(54) ROTATING DETONATION ENGINE COMBUSTOR WAVE REFLECTOR

(71) Applicant: UNITED TECHNOLOGIES CORPORATION, Farmington, CT (US)

(72) Inventors: Christopher Britton Greene, East Hartford, CT (US); Adam Takashi Holley, Manchester, CT (US); Peter AT Cocks, East Hartford, CT (US)

(73) Assignee: UNITED TECHNOLLGIES CORPORATION, Farmington, CT (US)

(21) Appl. No.: 15/470,796

(22) Filed: Mar. 27, 2017

(51) Int. Cl. F23R 7/00; F02C 3/04

(52) U.S. Cl. CPC F23R 7/00; F02C 5/00; F05D 2240/35; F02C 3/04

(57) ABSTRACT

A rotating detonation engine includes an annulus having a first wall, a second wall, and a volume having a detonation region in which a mixture of an oxidizer and a fuel detonate in a rotating fashion to create a pressure wave and detonation exhaust, the volume defining a downstream outlet through which detonation exhaust flows. The engine further includes an oxidizer outlet to output oxidizer and a fuel outlet to output fuel into the volume. The engine further includes an obstacle positioned in the volume and extending for an obstacle distance between the first wall and the second wall that is at least twenty five percent of an annulus distance from the first wall to the second wall, the obstacle designed to reflect the pressure wave such that a reflection of the pressure wave travels downstream and reduces an amount of the detonation exhaust that travels upstream.

### GOVERNMENT LICENSE RIGHTS

This disclosure was made with government support under contract N68936-15-C-0012 and awarded by the United States Defense Advanced Research Projects Agency. The government has certain rights in the disclosure.

### FIELD

The present disclosure is directed to rotating detonation engines and, more particularly, to a rotating detonation engine designed to reduce an upstream flow of combustion exhaust.

### BACKGROUND

Gas turbine engines include a compressor section, a turbine section, and a combustor section. The compressor section receives air from the environment and uses various rotors and stators to compress the air. The combustor section receives the compressed air and fuel, mixes the compressed air and fuel, and combusts the mixture to generate thrust. Exhaust from the combustor section is received by the turbine section which converts the exhaust into torque, a portion of which may be transferred to the compressor section. Recently, there has been research on the use of rotating detonation engines as combustors for gas turbine engines and other direct thrust applications such as ramjet and augmentor combustors. Each passing detonation may generate a pressure wave and hot exhaust gases. The pressure wave and the hot exhaust gases may travel both upstream and downstream from the location of detonation. Various plenums exist upstream from the location of combustion and may contain oxidizer and or fuel. It is undesirable for the hot exhaust gases to reach the various plenums.

### SUMMARY

Disclosed herein is a rotating detonation engine. The rotating detonation engine includes an annulus having a first wall and a second wall that define a volume therebetween, the volume having a detonation region configured for a mixture of an oxidizer and a fuel to detonate in a rotating fashion to create a pressure wave and detonation exhaust, the volume defining a downstream outlet through which the detonation exhaust flows. The rotating detonation engine further includes an oxidizer outlet configured to output the oxidizer into the volume. The rotating detonation engine further includes a fuel outlet configured to output the fuel into the volume. The rotating detonation engine further includes an obstacle positioned in the volume and extending for an obstacle distance between the first wall and the second wall that is at least twenty five percent of an annulus distance from the first wall to the second wall, the obstacle being configured to reflect the pressure wave such that a reflection of the pressure wave travels downstream and reduces an amount of the detonation exhaust that travels upstream.

Any of the foregoing embodiments may also include a fuel plenum configured to contain the fuel, and a fuel channel coupled to the fuel plenum and the fuel outlet, configured to transport the fuel from the fuel plenum to the volume, and having a length that is sufficiently great to prevent the detonation exhaust from reaching the fuel plenum.

Any of the foregoing embodiments may also include an oxidizer plenum configured to contain the oxidizer, and an oxidizer channel coupled to the oxidizer plenum and the oxidizer outlet, configured to transport the oxidizer from the oxidizer plenum to the volume, and having a length that is sufficiently great to prevent the detonation exhaust from reaching the oxidizer plenum.

In any of the foregoing embodiments, the length of the oxidizer channel is selected based on a frequency of rotation of detonation and a convection velocity of the detonation exhaust.

In any of the foregoing embodiments, the obstacle has a face that faces towards the downstream outlet and forms an angle with the first wall of the annulus that is between 15 degrees and 120 degrees.

In any of the foregoing embodiments, the obstacle has a face that faces towards the downstream outlet and is at least one of straight or concave.

In any of the foregoing embodiments, the obstacle includes a first obstacle extending from the first wall towards the second wall and having a first obstacle distance from the first wall towards the second wall, the obstacle includes a second obstacle extending from the second wall towards the first wall and having a second obstacle distance from the second wall towards the first wall, and a sum of the first obstacle distance and the second obstacle distance is at least twenty five percent of the annulus distance from the first wall to the second wall.

In any of the foregoing embodiments, the obstacle is located upstream from the detonation region.

In any of the foregoing embodiments, the fuel is injected into the volume in a direction that forms an angle with the first wall of the annulus that is between negative 90 degrees and 90 degrees.

In any of the foregoing embodiments, the oxidizer is injected into the volume in a direction that forms an angle with the first wall of the annulus that is between negative 90 degrees and 90 degrees.

Also disclosed is a rotating detonation engine. The rotating detonation engine includes an annulus having a first wall and a second wall that define a volume therebetween, the volume having a detonation region configured for a mixture of an oxidizer and a fuel to detonate in a rotating fashion to create a pressure wave and detonation exhaust, the volume defining a downstream outlet through which the detonation exhaust flows. The rotating detonation engine also includes an oxidizer plenum configured to contain the oxidizer. The rotating detonation engine also includes an oxidizer outlet configured to output the oxidizer into the volume. The rotating detonation engine also includes an oxidizer channel configured to transport the oxidizer from the oxidizer plenum to the oxidizer outlet and having a length that is sufficiently great to prevent the detonation exhaust from reaching the oxidizer plenum. The rotating detonation engine also includes a fuel outlet configured to output the fuel into the volume. The rotating detonation engine also includes an obstacle positioned in the volume and configured to reflect the pressure wave such that a reflection of the pressure wave travels downstream and reduces an amount of the detonation exhaust that travels upstream.

In any of the foregoing embodiments, the length of the oxidizer channel is selected based on a frequency of rotation of detonation and a convection velocity of the detonation exhaust.

In any of the foregoing embodiments, the obstacle has a face that faces towards the downstream outlet and forms an angle with the first wall of the annulus that is between 15 degrees and 120 degrees.

In any of the foregoing embodiments, the obstacle extends for an obstacle distance between the first wall and the second wall that is at least twenty five percent of an annulus distance from the first wall to the second wall.

In any of the foregoing embodiments, the obstacle has a face that faces towards the downstream outlet and is at least one of straight or concave.

In any of the foregoing embodiments, the obstacle includes a first obstacle extending from the first wall towards the second wall and having a first obstacle distance from the first wall towards the second wall, the obstacle includes a second obstacle extending from the second wall towards the first wall and having a second obstacle distance from the second wall towards the first wall, and a sum of the first obstacle distance and the second obstacle distance is at least twenty five percent of an annulus distance from the first wall to the second wall.

In any of the foregoing embodiments, the obstacle is located upstream from the detonation region.

Also disclosed is a gas turbine engine. The gas turbine engine includes a turbine section configured to convert detonation exhaust into torque. The gas turbine engine also includes a compressor section configured to receive the torque from the turbine section and to utilize the torque to compress fluid. The gas turbine engine also includes a rotating detonation engine configured to generate the detonation exhaust. The rotating detonation engine includes an annulus having a first wall and a second wall that define a volume therebetween, the volume having a detonation region configured for a mixture of an oxidizer and a fuel to detonate in a rotating fashion to create a pressure wave and the detonation exhaust, the volume defining a downstream outlet through which the detonation exhaust flows. The rotating detonation engine also includes an oxidizer outlet configured to output the oxidizer into the volume. The rotating detonation engine also includes a fuel outlet configured to output the fuel into the volume. The rotating detonation engine also includes an obstacle positioned in the volume and extending for an obstacle distance between the first wall and the second wall that is at least twenty five percent of an annulus distance from the first wall to the second wall, the obstacle being configured to reflect the pressure wave such that a reflection of the pressure wave travels downstream and reduces an amount of the detonation exhaust that travels upstream.

In any of the foregoing embodiments the rotating detonation engine further includes an oxidizer plenum configured to contain the oxidizer, and an oxidizer channel coupled to the oxidizer plenum and the oxidizer outlet, configured to transport the oxidizer from the oxidizer plenum to the volume, and having a length that is sufficiently great to prevent the detonation exhaust from reaching the oxidizer plenum.

In any of the foregoing embodiments, the length of the oxidizer channel is selected based on a frequency of rotation of detonation and a convection velocity of the detonation exhaust.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed, non-limiting, embodiments. The drawings that accompany the detailed description can be briefly described as follows:

FIG. 1 is a schematic cross-section of a gas turbine engine having a rotating detonation engine, in accordance with various embodiments;

FIGS. 2A, 2B, and 2C are drawings illustrating various features of a rotating detonation engine, in accordance with various embodiments;

FIGS. 3A, 3B, and 3C are drawings illustrating rotation of the detonation of the rotating detonation engine of FIGS. 2A, 2B, and 2C, in accordance with various embodiments;

FIG. 4 is a drawing illustrating a rotating detonation engine having an obstacle for reducing upstream flow of hot exhaust gases, in accordance with various embodiments;

FIGS. 5A, 5B, 5C, 5D, and 5E are drawings illustrating rotating detonation engines having obstacles of various shapes for reducing upstream flow of hot exhaust gases, in accordance with various embodiments;

FIGS. 6A and 6B are drawings illustrating rotating detonation engines having detonation regions located at various distances from an obstacle, in accordance with various embodiments;

FIGS. 7A and 7B are drawings illustrating rotating detonation engines having oxidizer inlets designed to inject oxidizer into an annulus at different angles, in accordance with various embodiments; and

FIGS. 8A, 8B, and 8C are drawings illustrating rotating detonation engines having obstacles located on different walls of an annulus, in accordance with various embodiments.

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact. Cross hatching lines may be used throughout the figures to denote different parts but not necessarily to denote the same or different materials.

As used herein, “aft” refers to the direction associated with the exhaust (e.g., the back end) of a gas turbine engine. As used herein, “forward” refers to the direction associated with the intake (e.g., the front end) of a gas turbine engine.

As used herein, “radially outward” refers to the direction generally away from the axis of rotation of a turbine engine. As used herein, “radially inward” refers to the direction generally towards the axis of rotation of a turbine engine.

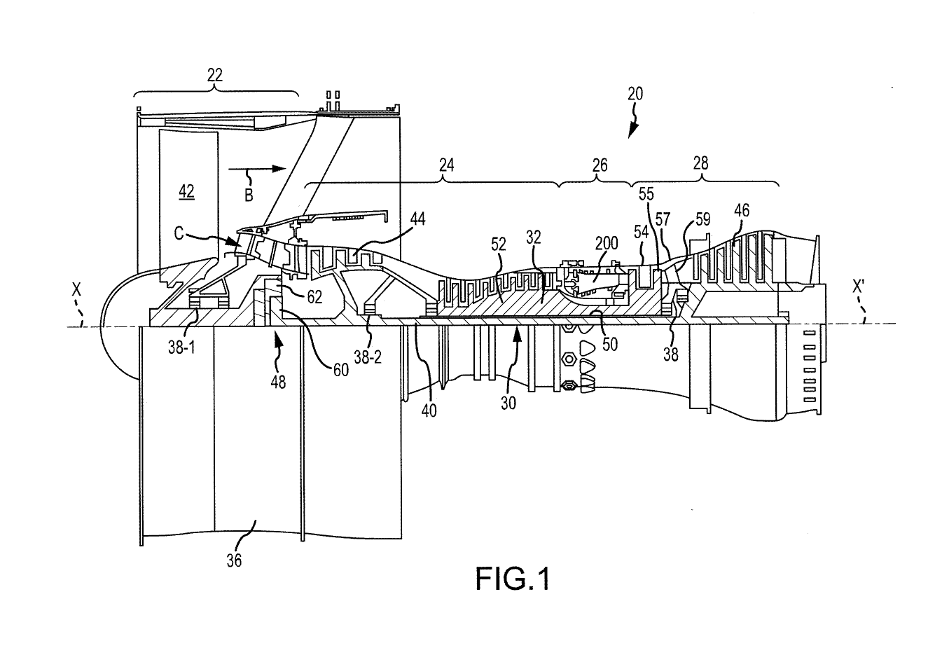

In various embodiments and with reference to FIG. 1, a gas turbine engine 20 is provided. The gas turbine engine 20 may be a two-spool turbofan that generally incorporates a fan section 22, a compressor section 24, a combustor section 26 and a turbine section 28. Alternative engines may include, for example, an augmentor section among other systems or features. In operation, the fan section 22 can drive coolant (e.g., air) along a bypass flow path B while the compressor section 24 can drive coolant along a core flow path C for compression and communication into the combustor section 26 then expansion through the turbine section 28. Although depicted as a two-spool turbofan gas turbine engine 20 herein, it should be understood that the concepts described herein are not limited to use with two-spool turbofans as the teachings may be applied to other types of turbine engines including turbojet, turboprop, turboshaft, or power generation turbines, with or without geared fan, geared compressor or three-spool architectures.

The gas turbine engine 20 may generally comprise a low speed spool 30 and a high speed spool 32 mounted for rotation about an engine central longitudinal axis A-A′ relative to an engine static structure 36 or engine case via several bearing systems 38, 38-1, and 38-2. It should be understood that various bearing systems 38 at various locations may alternatively or additionally be provided, including for example, the bearing system 38, the bearing system 38-1, and the bearing system 38-2.

The low speed spool 30 may generally comprise an inner shaft 40 that interconnects a fan 42, a low pressure compressor 44 and a low pressure turbine 46. The inner shaft 40 may be connected to the fan 42 through a geared architecture 48 that can drive the fan 42 at a lower speed than the low speed spool 30. The geared architecture 48 may comprise a gear assembly 60 enclosed within a gear housing 62. The gear assembly 60 couples the inner shaft 40 to a rotating fan structure. The high speed spool 32 may comprise an outer shaft 50 that interconnects a high pressure compressor 52 and high pressure turbine 54. A rotating detonation engine 200 may be located between high pressure compressor 52 and high pressure turbine 54. A mid-turbine frame 57 of the engine static structure 36 may be located generally between the high pressure turbine 54 and the low pressure turbine 46. Mid-turbine frame 57 may support one or more bearing systems 38 in the turbine section 28. The inner shaft 40 and the outer shaft 50 may be concentric and rotate via bearing systems 38 about the engine central longitudinal axis A-A′, which is collinear with their longitudinal axes. As used herein, a “high pressure” compressor or turbine experiences a higher pressure than a corresponding “low pressure” compressor or turbine.

The airflow of core flow path C may be compressed by the low pressure compressor 44 then the high pressure compressor 52, mixed and burned with fuel in the rotating detonation engine 200, then expanded over the high pressure turbine 54 and the low pressure turbine 46. The turbines 46, 54 rotationally drive the respective low speed spool 30 and high speed spool 32 in response to the expansion.

The gas turbine engine 20 may be, for example, a high-bypass ratio geared engine. In various embodiments, the bypass ratio of the gas turbine engine 20 may be greater than about six (6). In various embodiments, the bypass ratio of the gas turbine engine 20 may be greater than ten (10). In various embodiments, the geared architecture 48 may be an epicyclic gear train, such as a star gear system (sun gear in meshing engagement with a plurality of star gears supported by a carrier and in meshing engagement with a ring gear) or other gear system. The geared architecture 48 may have a gear reduction ratio of greater than about 2.3 and the low pressure turbine 46 may have a pressure ratio that is greater than about five (5). In various embodiments, the bypass ratio of the gas turbine engine 20 is greater than about ten (10:1). In various embodiments, the diameter of the fan 42 may be significantly larger than that of the low pressure compressor 44, and the low pressure turbine 46 may have a pressure ratio that is greater than about five (5:1). The low pressure turbine 46 pressure ratio may be measured prior to the inlet of the low pressure turbine 46 as related to the pressure at the outlet of the low pressure turbine 46 prior to an exhaust nozzle. It should be understood, however, that the above parameters are exemplary of various embodiments of a suitable geared architecture engine and that the present disclosure contemplates other gas turbine engines including direct drive turbofans. A gas turbine engine may comprise an industrial gas turbine (IGT) or a geared engine, such as a geared turbofan, or non-geared engine, such as a turbofan, a turboshaft, or may comprise any gas turbine engine as desired.

In various embodiments, the low pressure compressor 44, the high pressure compressor 52, the low pressure turbine 46, and the high pressure turbine 54 may comprise one or more stages or sets of rotating blades and one or more stages or sets of stationary vanes axially interspersed with the associated blade stages but non-rotating about engine central longitudinal axis A-A′. The compressor and turbine sections 24, 28 may be referred to as rotor systems. Within the rotor systems of the gas turbine engine 20 are multiple rotor disks, which may include one or more cover plates or minidisks. Minidisks may be configured to receive balancing weights or inserts for balancing the rotor systems.

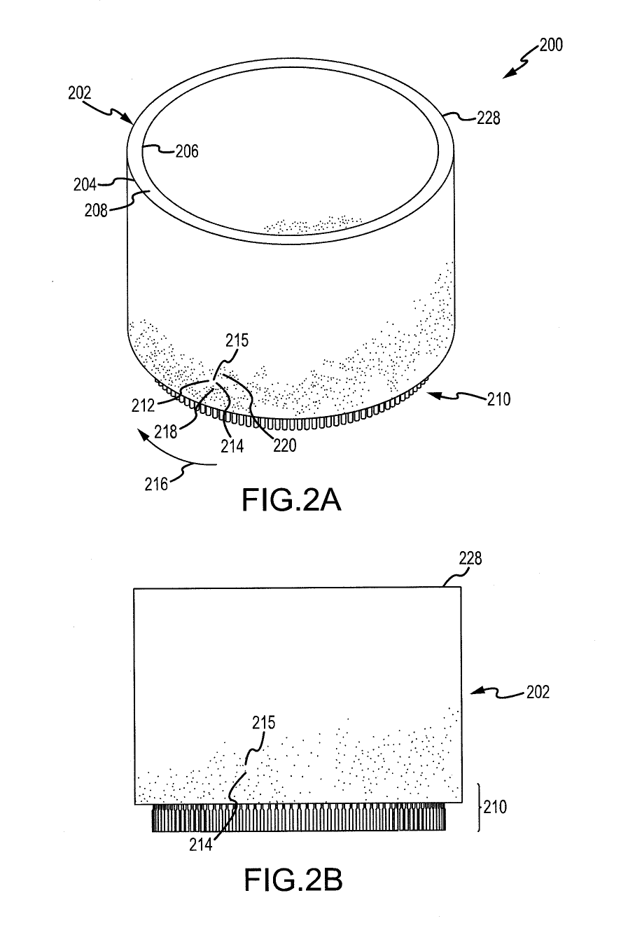

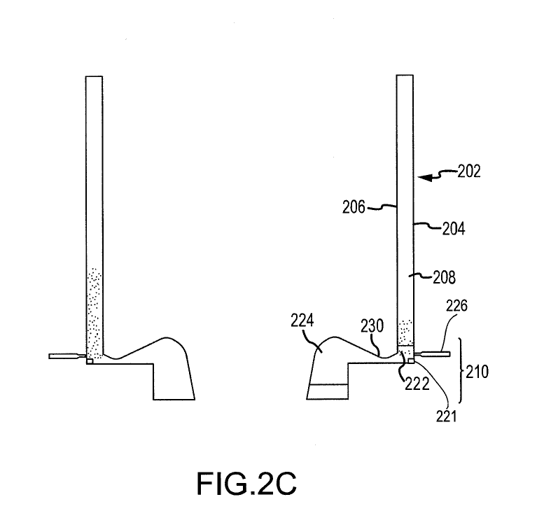

Referring now to FIGS. 2A, 2B, and 2C, the rotating detonation engine 200 may include an annulus 202 including an outer cylinder 204 and an inner cylinder 206. The outer cylinder 204 and the inner cylinder 206 may define a volume 208 therebetween. Although the rotating detonation engine 200 is shown as an annular structure, one skilled in the art will realize that a rotating detonation engine may have any shape that provides a continuous path for detonation to follow. For example, a rotating detonation engine may have an elliptical shape, a trapezoidal shape, or the like. In that regard, where used in this context, “annulus” may refer to any continuous circumferential channel having annular or any other shape such as trapezoidal or elliptical. Furthermore, where used herein, “annular volume” may likewise refer to any continuous circumferential channel having an annular or any other shape such as trapezoidal or elliptical.

Furthermore, although the rotating detonation engine 200 is shown in use in a gas turbine engine, one skilled in the art will realize that a rotating detonation engine may be used as a combustor in any other system, such as a ramjet engine, an augmentor section of an engine, or the like.

A fuel mixer 210 may be positioned upstream from the annulus 202 and may provide a fuel mixture 212 including a combustible blend of an oxidizer and a fuel. The fuel mixture 212 may be continuously introduced into the volume 208. The rotating detonation engine 200 may then be initialized, causing a detonation 214 to occur. The detonation 214 corresponds to an ignition or combustion of the fuel mixture 212 at a particular location about a circumference of the annulus 202.

The detonation 214 may then continuously travel around the circumference of the annulus 202. As shown in FIG. 2A, the detonation 214 may occur at a location 215 and may travel in a direction illustrated by an arrow 216. A first location 218 within the volume 208 and preceding the detonation 214 may include a relatively large density of the fuel mixture 212. As the detonation 214 reaches the first location 218, the density of the fuel mixture 212 allows the fuel mixture 212 to detonate.

After the detonation occurs, the fuel mixture 212 may be burned away and the force of the detonation 214 may temporarily resist entry of additional fuel mixture 212 into the volume 208. Accordingly, a second location 220 that has recently detonated may have a relatively low density of the fuel mixture 212. In that regard, the detonation 214 may continue to rotate about the volume 208 in the direction shown by the arrow 216.

The detonation 214 may generate detonation exhaust. The rotating detonation engine 200 may include a downstream outlet 228 through which the detonation exhaust travels prior to reaching the turbine section 28 of FIG. 1. The detonation 214 will generate a pressure wave that travels upstream. Where used in this context, upstream refers to a direction towards the compressor section 24 of FIG. 1, and downstream refers to a direction towards the turbine section 28 of FIG. 1.

The fuel mixer 210 may be designed to blend and output the fuel mixture 212. In particular, the fuel mixer 210 may include a combustion channel 222, an oxidizer outlet 224, and a fuel outlet 226. The combustion channel 222, the oxidizer outlet 224, and the fuel outlet 226 may each include a metal or other material capable of withstanding relatively high temperatures such as one or more of an austenitic nickel-chromium-based alloy such as that sold under the trademark Inconel® which is available from Special Metals Corporation of New Hartford, New York, USA, or a stainless steel.

The oxidizer outlet 224 may output an oxidizer. The fuel outlet 226 may output a fuel. The fuel outlet 226 and the oxidizer outlet 224 may be positioned upstream from the combustion channel 222.

The oxidizer from the oxidizer outlet 224 and the fuel from the fuel outlet 226 may combine in the combustion channel 222 as the final mixture of the fuel and the oxidizer. The final mixture may be capable of detonation within one or both of the combustion channel 222 or the volume 208.

The rotating detonation engine 200 may further include an obstacle 221. The obstacle may be located upstream from a location of detonation. The obstacle 221 may include a metal or other material capable of withstanding relatively high temperatures such as one or more of an austenitic nickel-chromium-based alloy such as that sold under the trademark Inconel® which is available from Special Metals Corporation of New Hartford, New York, USA, or a stainless steel. The obstacle may reflect a pressure wave generated from the detonation. The reflection of the pressure wave may reduce an amount and a velocity of detonation exhaust that travels upstream (i.e., towards the fuel outlet 226 or the oxidizer outlet 224).

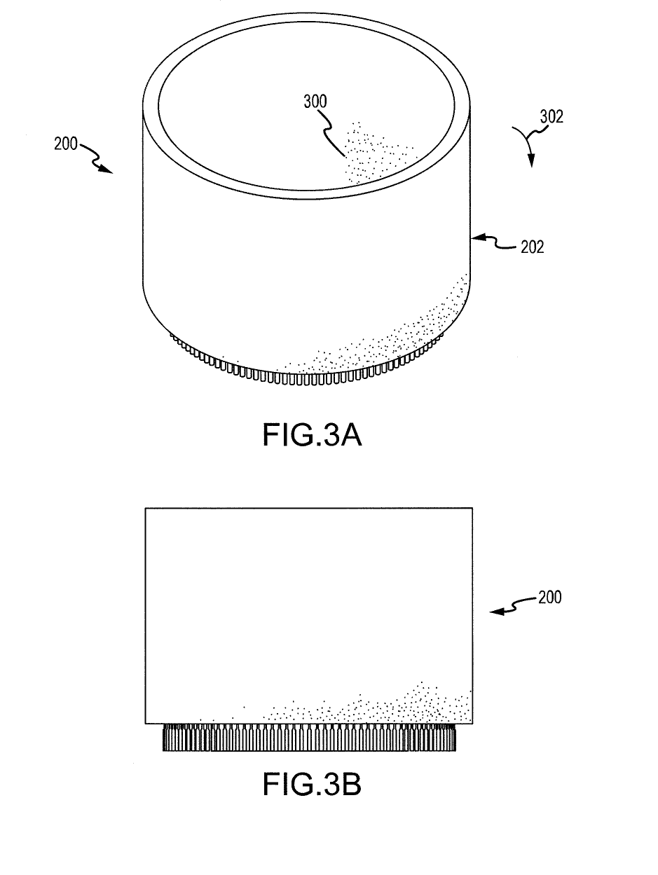

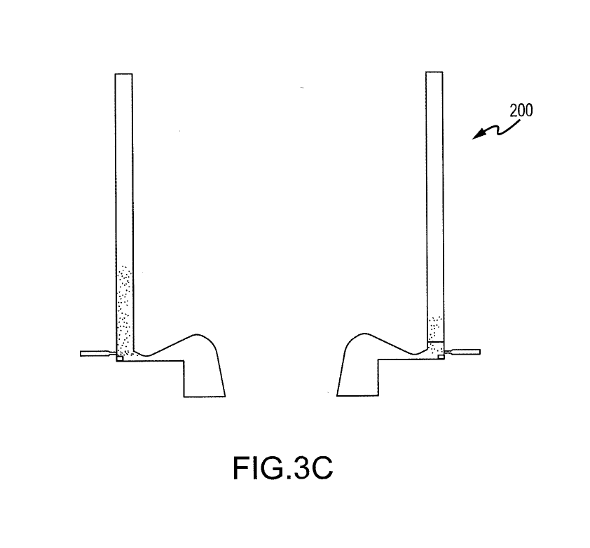

Referring now to FIGS. 3A, 3B, and 3C, the rotating detonation engine 200 is shown at a point in time later than shown in FIGS. 2A, 2B, and 2C. In particular, the rotating detonation engine 200 now has a detonation 300 at a different location than the detonation 214 of FIG. 2. As shown, the detonation 300 continues to travel counterclockwise about the annulus 202 as shown by an arrow 302. In various embodiments, a detonation of a rotating detonation engine may travel clockwise, counterclockwise, or both at the same time without departing from the scope of the present disclosure. In various embodiments, multiple detonation waves of the rotating detonation engine may travel simultaneously in the combustion chamber.

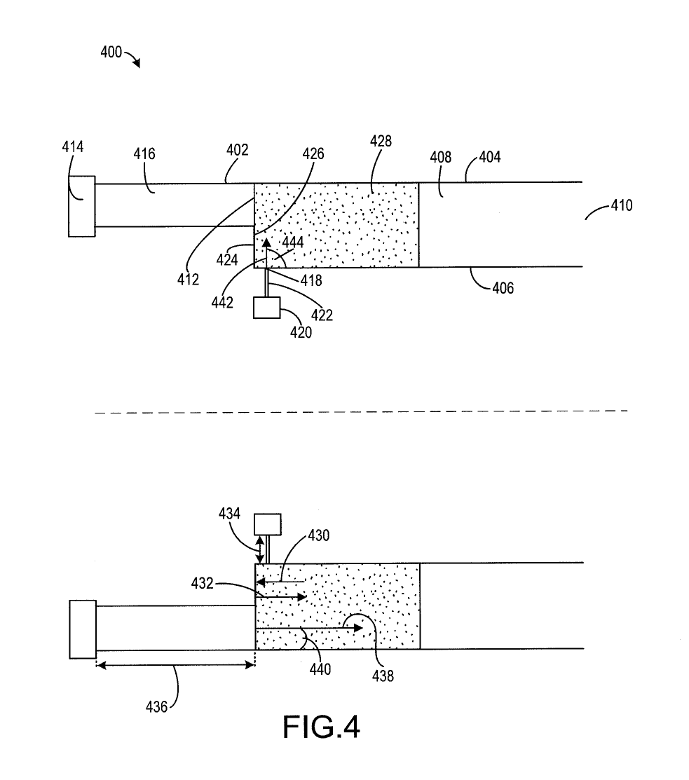

Turning now to FIG. 4, another rotating detonation engine 400 is shown. The rotating detonation engine 400 includes an annulus 402 having a first wall 404 and a second wall 406. A volume 408 may be defined between the first wall 404 and the second wall 406. The fuel and the oxidizer may mix within the volume 408 and combust. In response to such combustion, detonation exhaust may flow towards a downstream outlet 410.

The rotating detonation engine 400 may further include an oxidizer outlet 412, an oxidizer plenum 414, and an oxidizer channel 416. The oxidizer, such as air, may reside within the oxidizer plenum 414. Pressure may be applied to the oxidizer within the oxidizer plenum 414 causing the oxidizer to travel through the oxidizer channel 416 towards the oxidizer outlet 412. Upon reaching the oxidizer outlet 412, the oxidizer may flow into the volume 408.

The rotating detonation engine 400 may further include a fuel outlet 418, a fuel plenum 420, and a fuel channel 422. The fuel may reside within the fuel plenum 420. Pressure may be applied to the fuel within the fuel plenum 420, causing the fuel to travel through the fuel channel 422 towards the fuel outlet 418. Upon reaching the fuel outlet 418, the fuel may flow into the volume 408.

Upon reaching the volume 408, the fuel and the oxidizer may mix. A detonation region 428 may be defined within the volume 408. The mixture of the fuel and the oxidizer may reside within the detonation region 428 such that the mixture combusts as the rotating detonation reaches the particular location.

The combustion of the mixture of the fuel and the oxidizer may generate a pressure wave that travels downstream (towards the downstream outlet 410) and upstream (towards the oxidizer plenum 414). Furthermore, detonation exhaust (i.e., hot combustion gases) resulting from the combustion may also flow downstream and upstream. The detonation exhaust may be sufficiently hot that it may damage materials of the fuel plenum 420 or the oxidizer plenum 414. Furthermore, the detonation exhaust may be sufficiently hot to combust any residual fuel in the oxidizer plenum 414 or fuel in the fuel plenum 420 (if sufficient oxidizer is present within the fuel plenum 420). It is therefore undesirable for the detonation exhaust to reach the fuel plenum 420 or the oxidizer plenum 414.

In order to reduce the likelihood of the detonation exhaust reaching the fuel plenum 420 or the oxidizer plenum 414, the rotating detonation engine 400 may include an obstacle 424. The obstacle 424 may be located upstream from the detonation region 428 and may include a face 426 that faces downstream. As the detonation occurs, a pressure wave is generated having a portion 430 that propagates upstream. The portion 430 of the pressure wave may reach the face 426 of the obstacle 424. The portion 430 of the pressure wave may reflect from the face 426, causing a reflection 432 to propagate downstream.

The pressure wave generated by the detonation may have a greater velocity than that of the detonation exhaust. In that regard, the portion 430 of the pressure wave may reach the face 426 sufficiently fast that the reflection 432 reaches the detonation exhaust and reduces an amount and a velocity of detonation exhaust flowing upstream. The reflection 432 may apply sufficient pressure to the detonation exhaust to resist further upstream flow of the detonation exhaust. Furthermore, the obstacle 424 may reduce a magnitude of the pressure wave that travels through the oxidizer channel 416 such that a pressure differential between the oxidizer channel 416 and the volume 408 is sufficiently small to reduce an amount of detonation exhaust that may flow towards the oxidizer plenum 414. In various embodiments, the reflection 432 of the pressure wave and the pressure differential may be sufficiently great to prevent the detonation exhaust from reaching the fuel plenum 420 or the oxidizer plenum 414.

In addition to inclusion of the obstacle 424, the rotating detonation engine 400 may include additional features to reduce the likelihood of the detonation exhaust reaching the fuel plenum 420 or the oxidizer plenum 414. In particular, the fuel channel 424 may have a length 434. The length 434 may be selected to be sufficiently great that the detonation exhaust fails to reach the fuel plenum 420 before being overridden by the pressure within the fuel plenum 420. Likewise, the oxidizer channel 416 may have a length 436. The length 436 may be selected to be sufficiently great that the detonation exhaust fails to reach the oxidizer plenum 414 before being overridden by the pressure within the oxidizer plenum 414.

The length 434 of the fuel channel 422 and the length 436 of the oxidizer channel 416 may be selected based on various features of the rotating detonation engine 400. In particular, the length 434 and the length 436 may be selected based on a frequency of the rotating detonation within the rotating detonation engine 400, a convection velocity of the detonation exhaust, and an ambient pressure drop from the volume 408 into the fuel channel 422 and the oxidizer channel 416.

The fuel may be injected into the volume 408 via the fuel outlet 418 in a direction 442. The direction 442 may form an angle 444 with the second wall 406. In various embodiments, the angle 444 may be between negative 90 degrees and 90 degrees, negative 45 degrees and 45 degrees, or negative 30 degrees and 30 degrees.

The oxidizer may be injected into the volume 408 via the oxidizer outlet 412 in a direction 438. The direction 430 may form an angle 440 with the second wall 406. In various embodiments, the angle 440 may be between negative 90 degrees and 90 degrees, negative 45 degrees and 45 degrees, or negative 30 degrees and 30 degrees.

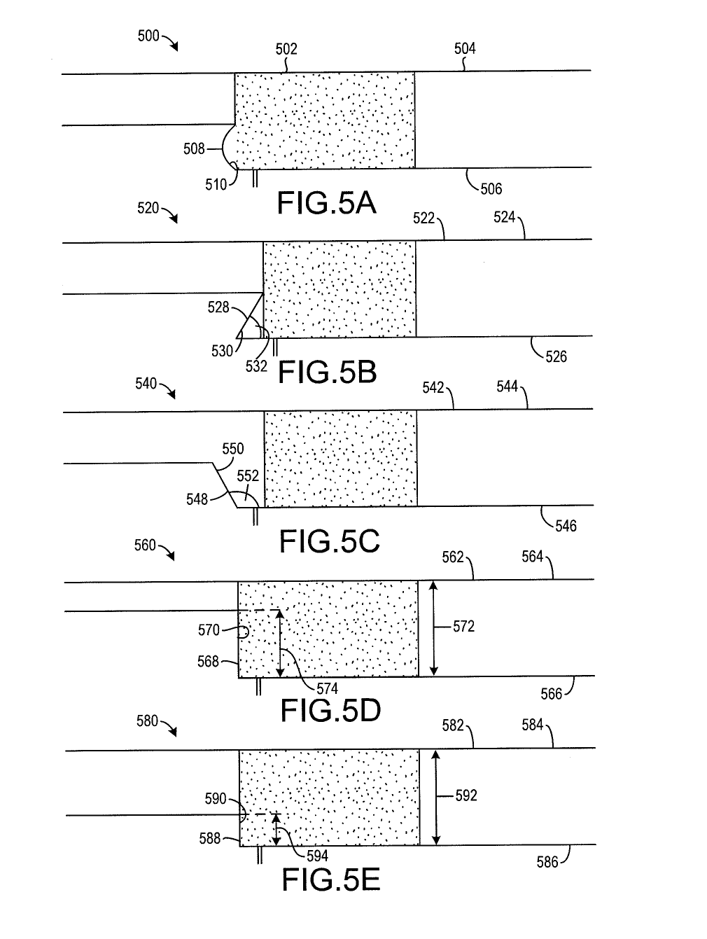

Referring to FIGS. 5A through 5E, features of various obstacles for reducing an amount and a velocity of detonation exhaust traveling upstream are shown. In particular and referring to FIG. 5A, a rotating detonation engine 500 includes an annulus 502 with a first wall 504 and a second wall 506. The rotating detonation engine 500 further includes an obstacle 508 having a face 510. In various embodiments, the face 510 may be straight, convex, or concave. As shown in FIG. 5A, the face 510 is concave.

Turning to FIG. 5B, another rotating detonation engine 520 includes an annulus 522 with a first wall 524 and a second wall 526. The rotating detonation engine 520 further includes an obstacle 528 having a face 530. The face 530 may be straight and may form an angle 532 with the second wall 526. In various embodiments, the angle 532 may be between 15 degrees and 120 degrees, between 15 degrees and 90 degrees, or between 45 degrees and 90 degrees. As shown, the angle 532 is approximately 50 degrees.

Turning to FIG. 5C, another rotating detonation engine 540 includes an annulus 542 with a first wall 544 and a second wall 546. The rotating detonation engine 540 further includes an obstacle 548 having a face 550. The face 550 may be straight and may form an angle 552 with the second wall 526. As shown, the angle 552 is approximately 15 degrees.

Turning to FIG. 5D, another rotating detonation engine 560 includes an annulus 562 with a first wall 564 and a second wall 566. The rotating detonation engine 560 further includes an obstacle 568 having a face 570. The face 570 extends from the second wall 566 towards the first wall 564 for an obstacle distance 574. The obstacle distance 574 may be a percentage of an annulus distance 572 from the first wall 564 to the second wall 566. In various embodiments, the obstacle distance 574 may be between 25 percent (25%) and 100%, between 25% and 75%, or between 35% and 65% of the annulus distance 572. As shown, the obstacle distance 574 in FIG. 5D is approximately 75% of the annulus distance 572.

Turning to FIG. 5D, another rotating detonation engine 580 includes an annulus 582 with a first wall 584 and a second wall 586. The rotating detonation engine 580 further includes an obstacle 588 having a face 590. The face 590 extends from the second wall 586 towards the first wall 584 for an obstacle distance 594. As shown in FIG. 5D, the obstacle distance 594 is approximately 25% of an annulus distance 592.

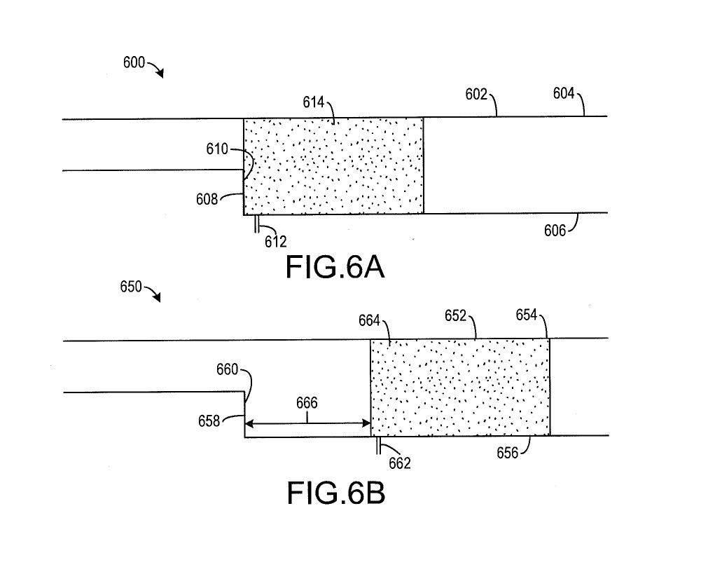

As described above, it is desirable for an obstacle of a rotating detonation engine to be located upstream from a detonation region. However, as shown in FIGS. 6A and 6B, a distance from the detonation region to the object may vary.

Turning to FIG. 6A, a rotating detonation engine 600 includes an annulus 602 with a first wall 604 and a second wall 606. The rotating detonation engine 600 further includes an obstacle 608 having a face 610. The rotating detonation engine 600 further includes a fuel outlet 612 that outputs fuel into the annulus 602. As shown, the fuel and the oxidizer mix to form a detonation region 614 that is located adjacent to and downstream from the face 610 of the obstacle 608.

Referring to FIG. 6B, another rotating detonation engine 650 includes an annulus 652 with a first wall 652 and a second wall 654. The rotating detonation engine 650 further includes an obstacle 658 having a face 660. The rotating detonation engine 650 further includes a fuel outlet 662 that outputs fuel into the annulus 652. As shown, the fuel and the oxidizer mix to form a detonation region 664. The detonation region 664 is located downstream from the face 660 of the object 658 and is separated from the face 660 by a distance 666. The distance 666 may be any distance and may be greater than the distance between the face 610 and the detonation region 614 of FIG. 6A. In various embodiments, it may be desirable for a detonation region to be relatively close to an obstacle, such as shown in FIG. 6A.

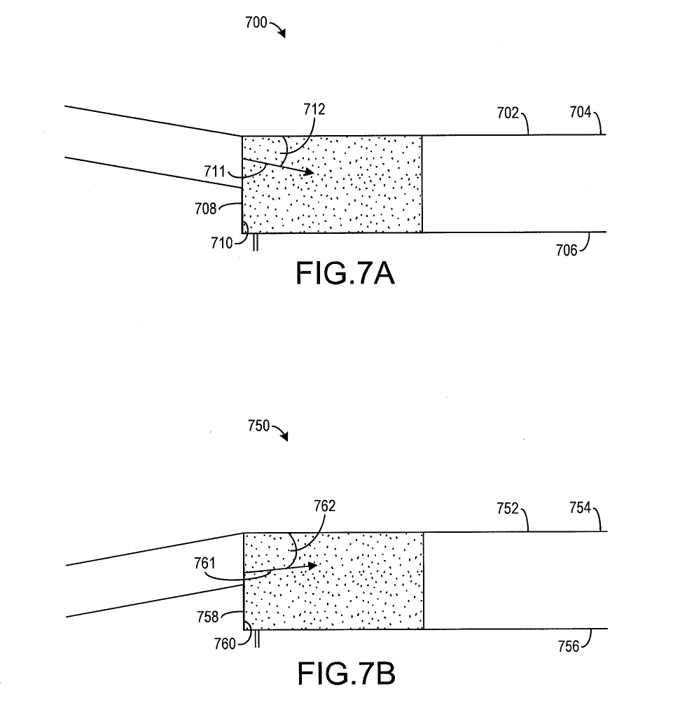

Referring to FIGS. 7A and 7B, an oxidizer may be injected into an annulus at various angles. FIG. 7A illustrates a rotating detonation engine 700 having an annulus 702 with a first wall 704 and a second wall 706. The rotating detonation engine 700 further includes an obstacle 708 having a face 710. Oxidizer is injected into the annulus 702 in a direction 711. The direction 711 may form an angle 712 with the first wall 704. In various embodiments, the angle 712 may be between negative 90 degrees and 90 degrees, negative 45 degrees and 45 degrees, or negative 30 degrees and 30 degrees. As shown in FIG. 7A, the angle 712 is approximately 20 degrees.

Turning to FIG. 7B, a rotating detonation engine 750 has an annulus 752 with a first wall 754 and a second wall 756. The rotating detonation engine 750 further includes an obstacle 758 having a face 760. Oxidizer is injected into the annulus 752 in a direction 761. The direction 761 may foil an angle 762 with the first wall 754. As shown in FIG. 7B, the angle 762 is approximately negative 20 degrees.

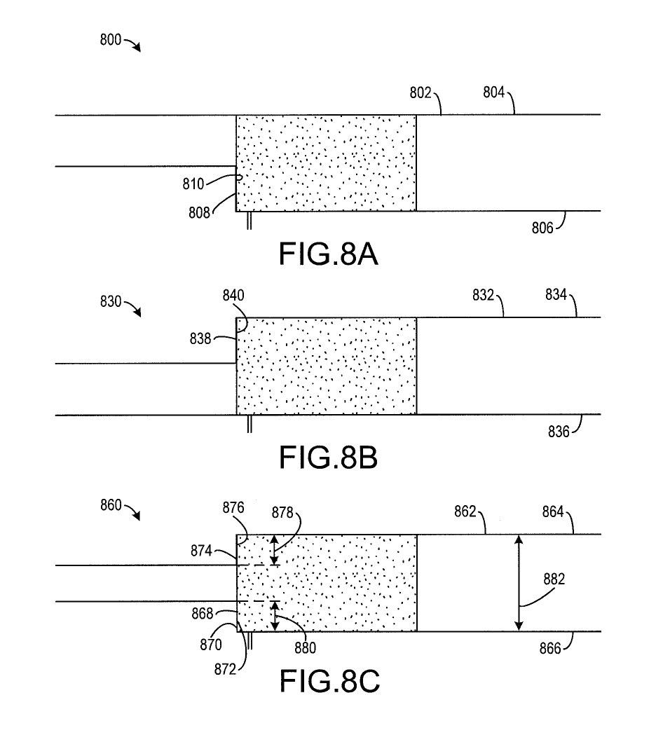

Referring to FIGS. 8A through 8C, an obstacle of a rotating detonation engine may be positioned on an inner wall of an annulus, an outer wall of an annulus, or both. FIG. 8A illustrates a rotating detonation engine 800 having an annulus 802 with an inner wall 804 and an outer wall 806. The rotating detonation engine 800 further includes an obstacle 808 with a face 810. The obstacle 808 extends from the outer wall 806 towards the inner wall 804.

Referring to FIG. 8B, a rotating detonation engine 830 includes an annulus 832 having an inner wall 834 and an outer wall 836. The rotating detonation engine 830 further includes an obstacle 838 having a face 840. The obstacle 838 extends from the inner wall 834 towards the outer wall 836.

Referring to FIG. 8C, a rotating detonation engine 860 includes an annulus 862 having an inner wall 864 and an outer wall 866. The rotating detonation engine 860 further includes an obstacle 868. The obstacle 868 includes a first obstacle 870 having a first face 872, and a second obstacle 874 having a second face 876. The first obstacle 870 extends from the outer wall 866 towards the inner wall 864. The second obstacle 874 extends from the inner wall 864 towards the outer wall 866.

The first obstacle 870 has a first obstacle distance 880 and the second obstacle 874 has a second obstacle distance 878. It is desirable for a total obstacle distance of the obstacle 868 to be at least 25% of an annulus distance 882 from the inner wall 864 to the outer wall 866. In that regard, it is desirable for a sum of the first obstacle distance 880 and the second obstacle distance 878 to be equal to at least 25% of the annulus distance 882.

While the disclosure is described with reference to exemplary embodiments, it will be understood by those skilled in the art that various changes may be made and equivalents may be substituted without departing from the spirit and scope of the disclosure. In addition, different modifications may be made to adapt the teachings of the disclosure to particular situations or materials, without departing from the essential scope thereof. The disclosure is thus not limited to the particular examples disclosed herein, but includes all embodiments falling within the scope of the appended claims.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of a, b, or c” is used in the claims, it is intended that the phrase be interpreted to mean that a alone may be present in an embodiment, b alone may be present in an embodiment, c alone may be present in an embodiment, or that any combination of the elements a, b and c may be present in a single embodiment; for example, a and b, a and c, b and c, or a and b and c. Different cross-hatching is used throughout the figures to denote different parts but not necessarily to denote the same or different materials.

Systems, methods and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A rotating detonation engine, comprising:
an annulus having a first wall and a second wall that define a volume therebetween, the volume having a detonation region configured for a mixture of an oxidizer and a fuel to detonate in a rotating fashion to create a pressure wave and detonation exhaust, the volume defining a downstream outlet through which the detonation exhaust flows;
an oxidizer outlet configured to output the oxidizer into the volume;
a fuel outlet configured to output the fuel into the volume; and
an obstacle positioned in the volume and extending for an obstacle distance between the first wall and the second wall that is at least twenty five percent of an annulus distance from the first wall to the second wall, the obstacle being configured to reflect the pressure wave such that a reflection of the pressure wave travels downstream and reduces an amount of the detonation exhaust that travels upstream.

2. The rotating detonation engine of claim 1, further comprising:
a fuel plenum configured to contain the fuel; and
a fuel channel coupled to the fuel plenum and the fuel outlet, configured to transport the fuel from the fuel plenum to the volume, and having a length that is sufficiently great to prevent the detonation exhaust from reaching the fuel plenum.

3. The rotating detonation engine of claim 1, further comprising:
an oxidizer plenum configured to contain the oxidizer; and
an oxidizer channel coupled to the oxidizer plenum and the oxidizer outlet, configured to transport the oxidizer from the oxidizer plenum to the volume, and having a length that is sufficiently great to prevent the detonation exhaust from reaching the oxidizer plenum.

4. The rotating detonation engine of claim 3, wherein the length of the oxidizer channel is selected based on a frequency of rotation of detonation and a convection velocity of the detonation exhaust.

5. The rotating detonation engine of claim 1, wherein the obstacle has a face that faces towards the downstream outlet and forms an angle with the first wall of the annulus that is between 15 degrees and 120 degrees.

6. The rotating detonation engine of claim 1, wherein the obstacle has a face that faces towards the downstream outlet and is at least one of straight or concave.

7. The rotating detonation engine of claim 1, wherein:
the obstacle includes a first obstacle extending from the first wall towards the second wall and having a first obstacle distance from the first wall towards the second wall;
the obstacle includes a second obstacle extending from the second wall towards the first wall and having a second obstacle distance from the second wall towards the first wall; and
a sum of the first obstacle distance and the second obstacle distance is at least twenty five percent of the annulus distance from the first wall to the second wall.

8. The rotating detonation engine of claim 1, wherein the obstacle is located upstream from the detonation region.

9. The rotating detonation engine of claim 1, wherein the fuel is injected into the volume in a direction that forms an angle with the first wall of the annulus that is between negative 90 degrees and 90 degrees.

10. The rotating detonation engine of claim 1, wherein the oxidizer is injected into the volume in a direction that forms an angle with the first wall of the annulus that is between negative 90 degrees and 90 degrees.

11. A rotating detonation engine, comprising:
an annulus having a first wall and a second wall that define a volume therebetween, the volume having a detonation region configured for a mixture of an oxidizer and a fuel to detonate in a rotating fashion to create a pressure wave and detonation exhaust, the volume defining a downstream outlet through which the detonation exhaust flows;
an oxidizer plenum configured to contain the oxidizer;
an oxidizer outlet configured to output the oxidizer into the volume;
an oxidizer channel configured to transport the oxidizer from the oxidizer plenum to the oxidizer outlet and having a length that is sufficiently great to prevent the detonation exhaust from reaching the oxidizer plenum;
a fuel outlet configured to output the fuel into the volume; and
an obstacle positioned in the volume and configured to reflect the pressure wave such that a reflection of the pressure wave travels downstream and reduces an amount of the detonation exhaust that travels upstream.

12. The rotating detonation engine of claim 11, wherein the length of the oxidizer channel is selected based on a frequency of rotation of detonation and a convection velocity of the detonation exhaust.

13. The rotating detonation engine of claim 11, wherein the obstacle has a face that faces towards the downstream outlet and forms an angle with the first wall of the annulus that is between 15 degrees and 120 degrees.

14. The rotating detonation engine of claim 11, wherein the obstacle extends for an obstacle distance between the first wall and the second wall that is at least twenty five percent of an annulus distance from the first wall to the second wall.

15. The rotating detonation engine of claim 11, wherein the obstacle has a face that faces towards the downstream outlet and is at least one of straight or concave.

16. The rotating detonation engine of claim 11, wherein:
the obstacle includes a first obstacle extending from the first wall towards the second wall and having a first obstacle distance from the first wall towards the second wall;
the obstacle includes a second obstacle extending from the second wall towards the first wall and having a second obstacle distance from the second wall towards the first wall; and
a sum of the first obstacle distance and the second obstacle distance is at least twenty five percent of an annulus distance from the first wall to the second wall.

17. The rotating detonation engine of claim 11, wherein the obstacle is located upstream from the detonation region.

18. A gas turbine engine, comprising:
a turbine section configured to convert detonation exhaust into torque;
a compressor section configured to receive the torque from the turbine section and to utilize the torque to compress fluid; and
a rotating detonation engine configured to generate the detonation exhaust and having:
an annulus having a first wall and a second wall that define a volume therebetween, the volume having a detonation region configured for a mixture of an oxidizer and a fuel to detonate in a rotating fashion to create a pressure wave and the detonation exhaust, the volume defining a downstream outlet through which the detonation exhaust flows,
an oxidizer outlet configured to output the oxidizer into the volume,
a fuel outlet configured to output the fuel into the volume, and
an obstacle positioned in the volume and extending for an obstacle distance between the first wall and the second wall that is at least twenty five percent of an annulus distance from the first wall to the second wall, the obstacle being configured to reflect the pressure wave such that a reflection of the pressure wave travels downstream and reduces an amount of the detonation exhaust that travels upstream.

19. The gas turbine engine of claim 18, wherein the rotating detonation engine further includes:
an oxidizer plenum configured to contain the oxidizer; and
an oxidizer channel coupled to the oxidizer plenum and the oxidizer outlet, configured to transport the oxidizer from the oxidizer plenum to the volume, and having a length that is sufficiently great to prevent the detonation exhaust from reaching the oxidizer plenum.

20. The gas turbine engine of claim 19, wherein the length of the oxidizer channel is selected based on a frequency of rotation of detonation and a convection velocity of the detonation exhaust.
